(19) United States
(12) Patent Application Publication
(10) Pub. No.: US 2009/0183924 A1
(43) Pub. Date: Jul. 23, 2009

(54) Tracked Hydrovacuum Vehicle

(75) Inventor: Larry D. TUTTLE, Drayton Valley (CA)

Correspondence Address: STEPHEN R. BURRI, MILLER THOMSON LLP, 1000 - 840 HOWE STREET, VANCOUVER, BC, V6Z 2M1, CA

(73) Assignee: GEOMETRIC PIPELINE SOLUTIONS INC., Drayton Valley (CA)

(21) Appl. No.: 12/358,769

(22) Filed: Jan. 23, 2009

Related U.S. Application Data
(60) Provisional application No. 61/023,062, filed on Jan. 23, 2008.

(51) Int. Cl. E21B 12/00; B62D 11/00

(52) U.S. Cl. 175/315; 180/6.7

(57) ABSTRACT

A tracked hydrovacuum vehicle combines a tracked vehicle and a hydrovacuum unit in a single machine with a single power source. The reduced weight and tracking of the modified machine permits operation of the device in boggy conditions. The compact size of the machine permits operation in congested areas.

### TECHNICAL FIELD OF THE INVENTION

The present invention relates to hydrovacuum excavation. In particular, the present invention relates to a novel vehicle for hydro-vacuum excavation in soft ground.

### BACKGROUND OF THE INVENTION

The oil and gas industry creates the need for the excavation of pipeline holes for installation of oil and gas pipelines. A desirable method of pipeline excavation is hydrovacuum excavation, in which high pressure water is used to loosen the materials to be removed, and high pressure vacuum is used to extract the materials from the excavation site.

Geological and other conditions in certain locations in which pipeline holes are required often produce very wet, muddy or boggy digging surfaces. Such surfaces are unable to support the heavy machinery commonly used to carry hydrovac units for hydrovacuum excavation for digging pipeline holes. To address this problem, prior art approaches to pipeline hole digging have included manual digging or use of small hydrovac units pulled by tractors.

It is known to provide tracked vehicles which use hydrovacuum excavation means. For example, in U.S. Pat. No. 6,922,922 to Cheramie there is disclosed an underwater dredging vehicle for wetland restoration. The tracked vehicle of this invention includes a cutterhead dredge system and directable discharge system for dredging and relocating submerged land. This machine is designed to operate underwater.

In U.S. Pat. No. 6,550,162 to Price and Christenson, there is described a sediment removal system in which a tracked vehicle runs along a seabed, towing a floating sediment removal device atop the water surface.

In PCT Patent Application No. PCT/GB98/02403 to Namibian Minerals Corporation Limited, there is described an underwater mining apparatus. The apparatus includes tracks, a suction boom, and a cutter head for extracting a solid mineral from a sub-surface layer. This invention operates on a solid seabed surface which can support the machine's weight.

It would be desirable to provide a relatively low weight, compact size machine for digging pipeline holes in muddy or congested areas. The present invention meets these objectives.

### SUMMARY OF THE INVENTION

According to one embodiment of the present invention, there is provided a tracked vehicle comprising excavation means and power supply means. The power supply means may be unitary power supply means. The unitary power supply means may supply power to operate the vehicle and the excavation means. The excavation means may be pressurized water delivery means and vacuum debris removal means.

According to another embodiment of the present invention, there is provided a machine for vacuum excavation comprising mobility means; excavation means; power supply means; and vacuum means. The mobility means may be wheeled tracks. The excavation means may comprise pressurized water delivery means and vacuum debris removal means. The power supply means may be unitary power supply means. The vacuum means may be an air blower and a cyclone assembly.

The pressurized water delivery means may comprise a water storage tank, a pump to pressurize the water, a hose to carry the pressurized water, and an overhead boom to support and direct the hose. The vacuum debris removal means may comprise an air blower and cyclone assembly to create a vacuum, a knife valve to control application of the vacuum, a hose to carry debris, an overhead boom to support and direct the hose, and a debris storage tank.

According to other embodiments of the present invention, there is provided a hydrovacuum unit adapted to use power from a tracked vehicle on which it is mounted, and a tracked vehicle adapted to carry and provide power to a hydrovacuum unit.

According to still other embodiments of the present invention, there is provided the use of the described vehicle, machine, hydrovacuum unit or tracked vehicle for pipeline hole hydrovacuum excavation.

One advantage of the present invention is the reduction in weight afforded by powering both the hydrovacuum extraction means and the mobility means from the same power source.

Another advantage of the present invention is the ability afforded by tracks to permit operation of the machine on soft ground.

Another advantage of the present invention is the maneuverability in congested sites permitted by its relatively small overall size and ability to make sharp turns and tight rotations permitted by the presence of tracks over a wheeled unit.

### BRIEF DESCRIPTION OF THE DRAWINGS

A detailed description of the preferred embodiments is provided by way of example only and with reference to the following drawings, in which:

FIG. 1 is a right side view of one embodiment of a tracked hydrovacuum vehicle, according to the invention;

FIG. 2 is a left side view of one embodiment of a tracked hydrovacuum vehicle, according to the invention;

FIG. 3 is an isometric view of a hydrovacuum assembly, according to the invention;

FIG. 4 is a top view of a hydrovacuum assembly, according to the invention;

FIG. 5 is an exploded view of a hydrovacuum assembly, according to the invention; and

FIG. 6 is a schematic illustrating the use of a single power source by the vehicle and the hydrovacuum apparatus, according to the invention.

In the drawings, embodiments of the invention are illustrated by way of example. It is to be expressly understood that the description and drawings are only for the purpose of illustration and as an aid to understanding, which are not intended as a definition of the limits of the invention.

### DETAILED DESCRIPTION OF THE INVENTION

According to one embodiment of the present invention, there is provided the combination of a modified tracked vehicle with a modified hydrovac unit for digging pipeline holes using water and a vacuum. The engine from the tracked vehicle is also used to provide power to the hydrovac unit. As a result of this efficiency, the overall weight of the machine is much less than the combined weights of an unmodified tracked vehicle and an unmodified hydrovacuum unit. This reduction in weight permits use of the machine in soft surfaced locations where prior art machinery has been unable to operate effectively.

A prior art tracked vehicle, such as a Morooka™ brand or Yanmar™ brand tracked vehicle, may provide the vehicle component of the tracked hydrovacuum vehicle of the invention. In such prior art vehicles, a materials box is commonly located behind the cab.

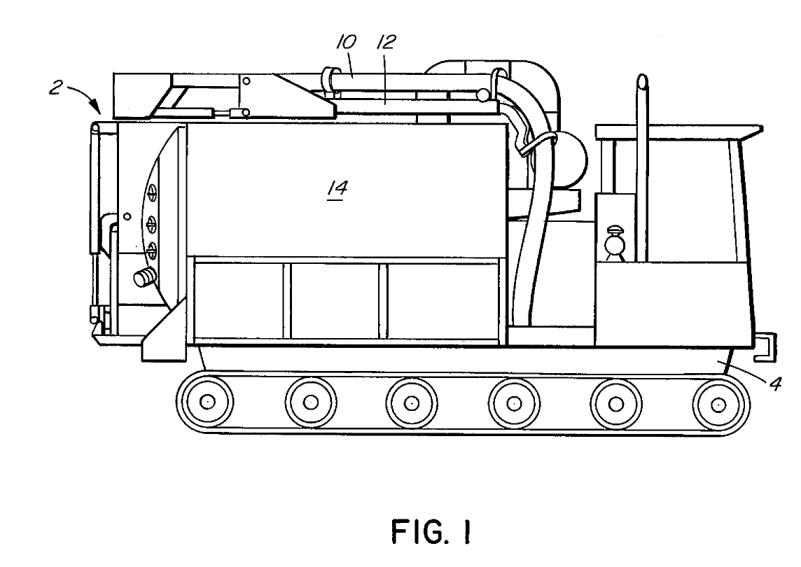

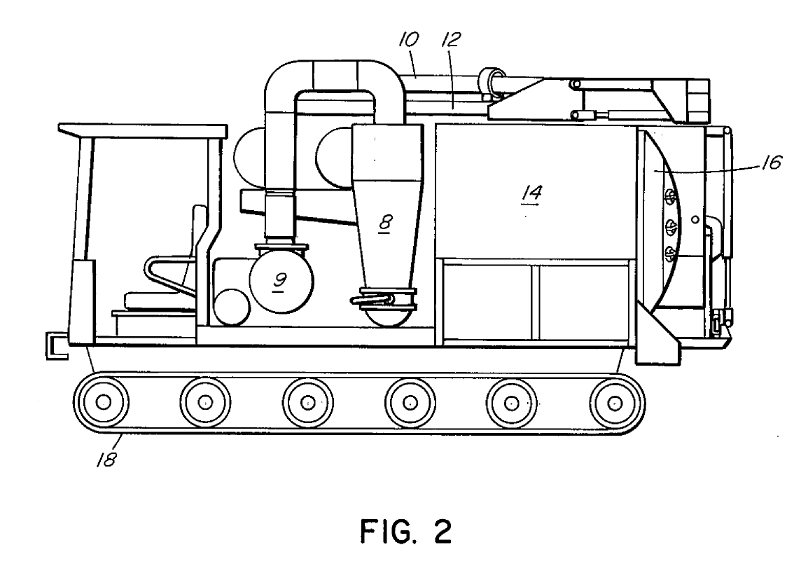

In FIGS. 1 and 2, the modified hydrovacuum apparatus of the present invention is mounted on a modified tracked vehicle in the location previously occupied by the materials box. The power supply of the prior art hydrovacuum unit has been removed in the modified hydrovacuum apparatus, with the modified hydrovacuum apparatus connected to the power supply of the modified tracked vehicle.

The hydrovacuum apparatus may be mounted on a variety of tracked vehicles, or tractors, for example a Morooka™ MST700, a Yanmar™ CG55, a Mitsubishi™ LD400 or a Mitsubishi™ LD1000 tractor. Other tractors may also be used. Larger tracked vehicles may also support the hydrovacuum apparatus of the present invention. Although larger tracked vehicles have greater weight, they also have a larger track footprint area, enabling them to maintain a relatively low ground pressure to permit operation of the hydrovacuum vehicle of the invention in a large vehicle format.

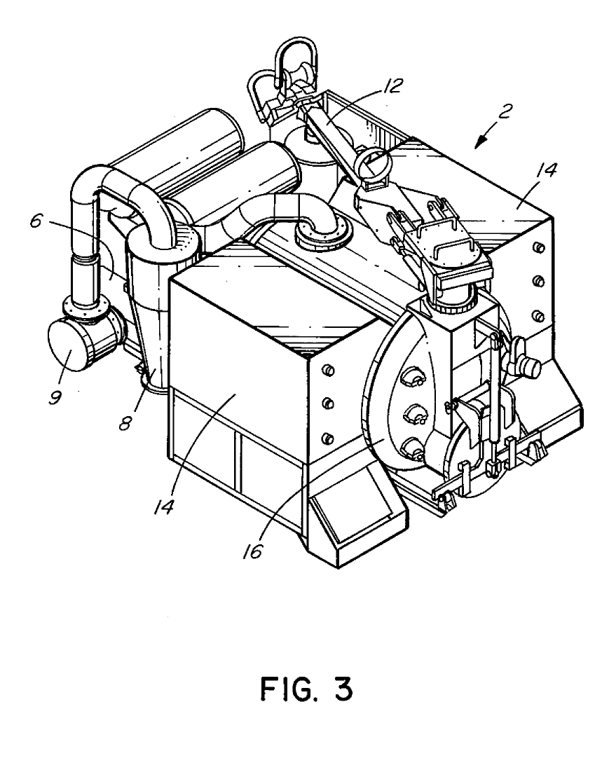

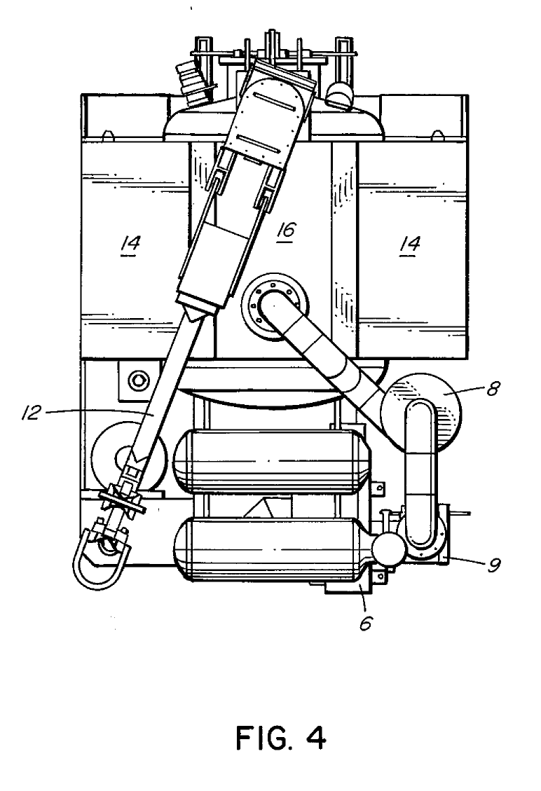

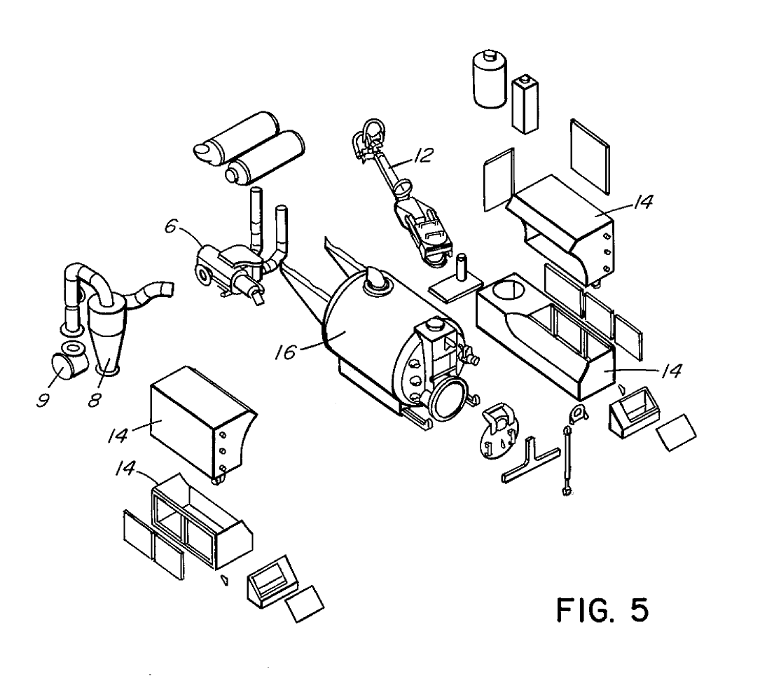

FIGS. 3, 4 and 5 depict the modified hydrovacuum apparatus. An air blower is used to create a vacuum in a cyclone assembly. A silencer assembly reduces noise generated by the air blower. The vacuum allows the hose (# in FIG. 1) to remove debris from the excavation hole for storage in the main tank of the hydrovacuum apparatus. The debris hose is supported and directed by an overhead boom. Water is stored in a tank before being pressurized and directed at the excavation site to loosen the soil and other debris for vacuum removal. Water is also delivered through the hose. A knife valve is used to build up vacuum and release it in quick bursts; thereby creating maximum vacuum for rocky or otherwise difficult conditions where more vacuum is required. Water is stored in the rectangular tank built around the central main vacuum tank. Water is gravity fed into a pump for redirection of the water to the excavation site.

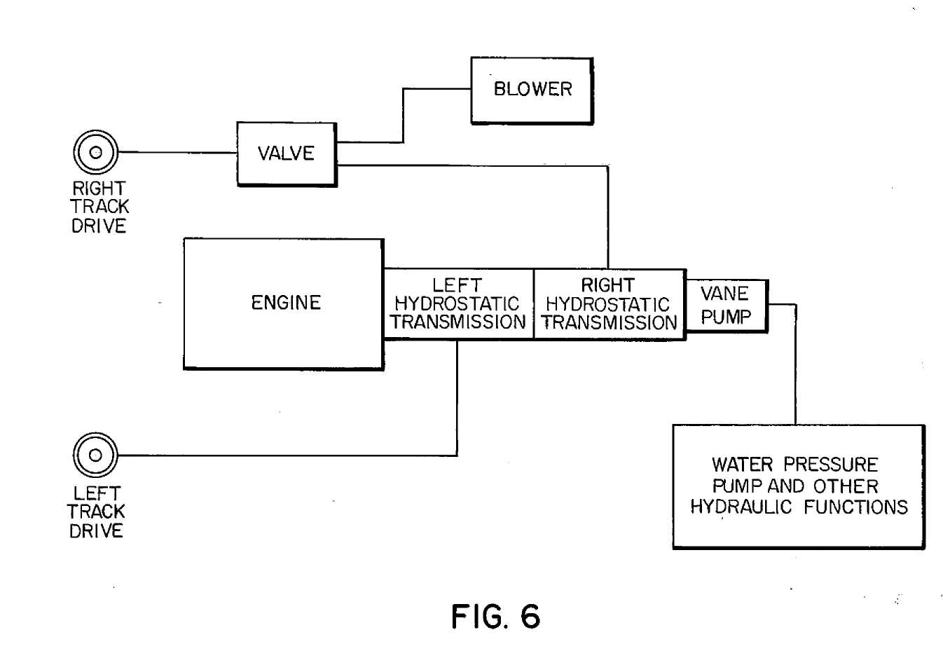

FIG. 6 depicts the use of a single engine with left and right hydrostatic transmissions (“HST”) and a vain pump to provide power to the tracks of the vehicle, to the air blower used to create the vacuum, to the water pressure pump and to all other hydraulic functions including the boom, the mudgate door, the hoist and the knife gate.

In operation, the tracked hydrovacuum vehicle is driven to a selected excavation site, the boom is positioned to direct the hose at the digging location, and water is directed at the surface to loosen soil and other debris. Intermittently, the knife valve is switched to create a vacuum for removal of debris and storage of debris in the main tank. Water digging and vacuum debris removal are simultaneous while the hydrovacuum apparatus is operating at the excavation site.

The invention uses a single power source to operate both the tracks of the vehicle and the hydrovacuum apparatus. The use of only one power source, as well as selection of a small vacuum, reduces the overall weight of the vehicle. This reduction in overall vehicle weight permits operation of the vehicle of the invention in boggy and muddy areas such as muskeg which can not support heavier machinery. The reduction in overall size permits operation of the hydrovacuum vehicle in congested areas where larger machines cannot manoeuver.

It will be appreciated by those skilled in the art that other variations of the preferred embodiment may also be practised without departing from the scope of the invention.

What is claimed is:

1 A tracked vehicle comprising:
excavation means; and
power supply means.

2. The tracked vehicle of claim 1, wherein the power supply means comprises unitary power supply means.

3. The tracked vehicle of claim 2, wherein the unitary power supply means comprises an engine for the tracked vehicle.

4. The tracked vehicle of claim 3, wherein the unitary power supply means supplies power to operate the vehicle and the excavation means.

5. The tracked vehicle of claim 4 wherein the excavation means comprises pressurized water delivery means and vacuum debris removal means.

6. The tracked vehicle of claim 5 wherein the pressurized water delivery means comprises a water storage tank, a pump to pressurize the water, a hose to carry the pressurized water, and an overhead boom to support and direct the hose.

7. The tracked vehicle of claim 6 wherein the vacuum debris removal means comprises an air blower and cyclone assembly to create a vacuum, a knife valve to control application of the vacuum, a hose to carry debris, an overhead boom to support and direct the hose, and a debris storage tank.

8. Use of the vehicle of claim 7 for pipeline hole excavation.

9. A machine for vacuum excavation comprising:
mobility means;
excavation means;
power supply means; and
vacuum means.

10. The machine of claim 9, wherein the mobility means comprises tracking.

11. The machine of claim 9 wherein the excavation means comprises pressurized water delivery means and vacuum debris removal means.

12. The machine of claim 11 wherein the pressurized water delivery means comprises a water storage tank, a pump to pressurize the water, a hose to carry the pressurized water, and an overhead boom to support and direct the hose.

13. The machine of claim 12 wherein the vacuum debris removal means comprises an air blower and cyclone assembly to create a vacuum, a knife valve to control application of the vacuum, a hose to carry debris, an overhead boom to support and direct the hose, and a debris storage tank.

14. The machine of claim 9, wherein the power supply means comprises unitary power supply means.

15. The machine of claim 9, wherein the vacuum means comprises an air blower, a cyclone assembly, and a knife valve to control application of the vacuum.

16. Use of the vehicle of claim 15 for pipeline hole excavation.

17. A hydrovacuum unit adapted to use power from a tracked vehicle on which it is mounted.

18. Use of the hydrovacuum unit of claim 17 for pipeline hole excavation.

19. A tracked vehicle adapted to carry and provide power to a hydrovacuum unit.

20. Use of the tracked vehicle of claim 19 for pipeline hole excavation.
